(19) United States
(12) Patent Application Publication
(10) Pub. No.: US 2025/0087192 A1
(43) Pub. Date: Mar. 13, 2025

(54) PICKUP FOR STRINGED INSTRUMENT AND GUITAR

(71) Applicant: YAMAHA CORPORATION, Hamamatsu-shi (JP)

(72) Inventor: Toshifumi KUNIMOTO, Hamamatsu-shi (JP)

(21) Appl. No.: 18/962,450

(22) Filed: Nov. 27, 2024

Related U.S. Application Data
(63) Continuation of application No. PCT/JP2023/018976, filed on May 22, 2023.

(30) Foreign Application Priority Data
May 30, 2022 (JP) 2022-087837

(51) Int. Cl. G10H 3/18

(52) U.S. Cl. CPC G10H 3/18

(57) ABSTRACT

A pickup for a stringed instrument that uses at least a first string, the pickup includes: a base plate including a first surface and a second surface opposite to the first surface; a first bobbin and a second bobbin arranged parallel with each other on the first surface of the base plate so that the first string extends across both the first and second bobbin in a state where the pickup is installed in the string instrument; a magnet disposed on the second surface of the base plate; a first pole piece extending into the first bobbin; and a second pole piece extending into the second bobbin. The magnet contacts at least one of the first pole piece or the second pole piece.

### CROSS-REFERENCE TO RELATED APPLICATIONS

This is a continuation of International Application No. PCT/JP2023/018976 filed on May 22, 2023, and claims priority from Japanese Patent Application No. 2022-087837 filed on May 30, 2022, the entire content of which is incorporated herein by reference.

### BACKGROUND

The present disclosure relates to a pickup used for a stringed instrument and a guitar with the pickup.

An electric guitar has a pickup that converts vibrations of strings into electrical signals. The pickup generally includes a base plate, a coil, a magnet, and a pole piece. The pole piece passes through an interior of a coil bobbin and is arranged to contact the magnet.

U.S. Pat. No. 9,552,802B2 discloses a pickup in which a magnet is arranged on a metal base plate. A coil bobbin is additionally arranged on the magnet.

U.S. Pat. No. 9,355,630B2 discloses a pickup in which a printed circuit board is used as a base plate. A magnet and a spacer are arranged on the base plate. A coil bobbin is additionally arranged on the magnet and the spacer.

### SUMMARY

In the pickup using a metal base plate, an assembly precision may deteriorate due to generation of a plastic deformation of metal. Specifically, the flatness of the metal base plate cannot be maintained, resulting in a deterioration of the assembly precision of each component arranged on the metal base plate. When the assembly precision deteriorates, the contact precision between the magnet and the pole piece deteriorates, potentially leading to an increase in a magnetic resistance. The increase in magnetic resistance causes a decrease in gain of the pickup.

In addition, a pickup with a configuration in which the magnet is arranged between the base plate and the coil has the problem that assembly is complicated. In addition, since the coil bobbin is arranged on the magnet and spacer, it is difficult to keep the coil bobbin horizontal, which also causes the deterioration of the assembly precision of the pickup.

An object of the present disclosure is to keep assembly precision of a pickup high.

An aspect of the present disclosure provides a pickup for a stringed instrument that uses at least a first string, the pickup including: a base plate including a first surface and a second surface opposite to the first surface; a first bobbin and a second bobbin arranged parallel with each other on the first surface of the base plate so that the first string extends across both the first and second bobbin in a state where the pickup is installed in the string instrument; a magnet disposed on the second surface of the base plate; a first pole piece extending into the first bobbin; and a second pole piece extending into the second bobbin, in which the magnet contacts at least one of the first pole piece or the second pole piece.

Another aspect of the present disclosure provides a guitar including: a body on which a first string extends; and a pickup disposed in or on the body and including: a base plate including a first surface and a second surface opposite to the first surface; a first bobbin and a second bobbin arranged parallel with each other on the first surface of the base plate so that the first string extends across both the first and second bobbin; a magnet disposed on the second surface of the base plate; a first pole piece extending into the first bobbin; and a second pole pieces extending into the second bobbin, in which the magnet contacts at least one of the first or second pole piece.

According to the present disclosure, it is possible to keep assembly precision of a pickup high.

### BRIEF DESCRIPTION OF THE DRAWINGS

The present disclosure will be described in detail based on the following without being limited thereto, wherein:

FIG. 1 is an exploded view of a pickup according to a first embodiment;

FIG. 2 is a side view of the pickup according to the first embodiment;

FIG. 3 is a side cross-sectional view of the pickup according to the first embodiment;

FIG. 4 is a plan view of a base plate;

FIG. 5 is a view showing eddy current formed on the base plate;

FIG. 6 is an exploded view of a pickup according to a second embodiment;

FIG. 7 is a side view of the pickup according to the second embodiment;

FIG. 8 is an exploded view of a pickup according to a modification; and

FIG. 9 is a plan view illustrating an electric guitar in a state in which the pickup is installed therein.

### DESCRIPTION OF EMBODIMENTS

### 1. First Embodiment

### {1. Pickup Configuration Overview}

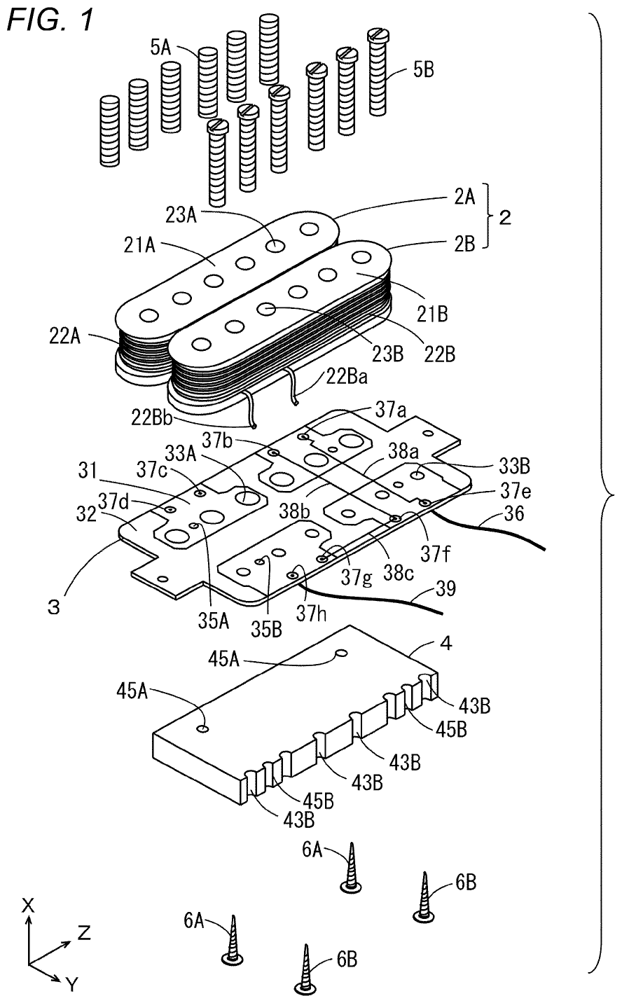

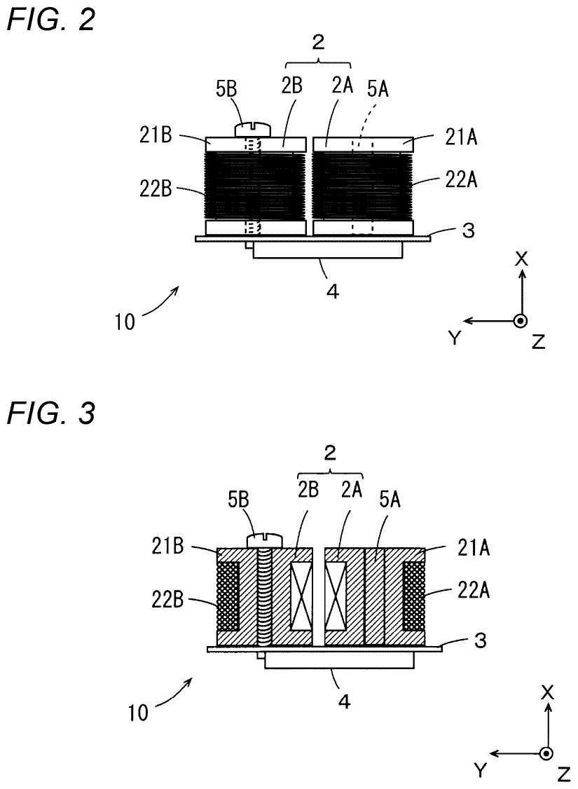

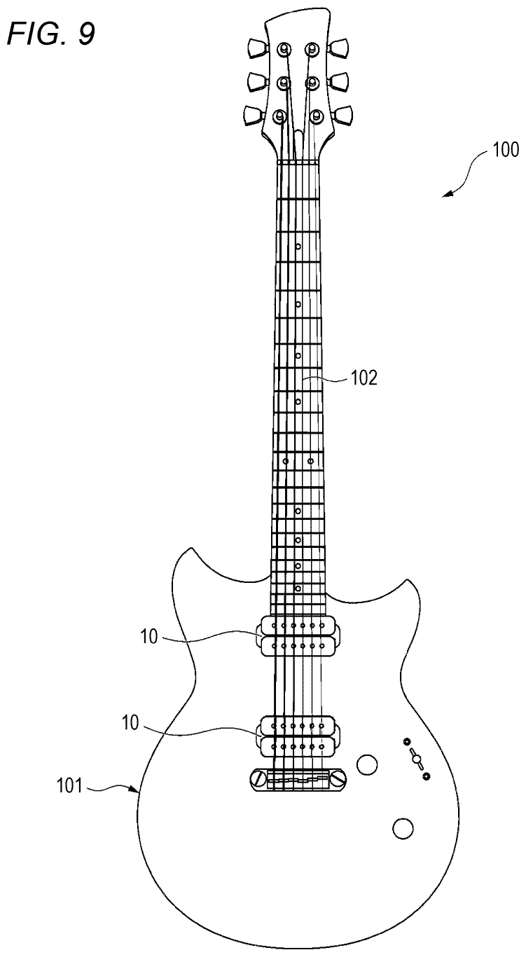

FIG. 1 is an exploded view showing a pickup 10 according to a first embodiment. In the following description, the X direction of each drawing is described as the up direction of the pickup 10, the Y direction is described as the front direction of the pickup 10, and the Z direction is described as the right direction of the pickup 10. FIG. 2 is a side view showing the pickup 10. FIG. 3 is a side cross-sectional view showing the pickup 10. FIG. 9 is a plan view illustrating an electric guitar 100 in a state in which the pickup 10 is installed therein. As shown in FIG. 1, the pickup 10 includes a coil 2, a base plate 3, a magnet 4, a pole piece 5A (slug), and a pole piece 5B (screw). The members of the pickup 10 are assembled as shown in FIGS.

2 and 3, and then fixed by screws 6A and 6B. The pickup 10 is incorporated into a stringed instrument. For example, the pickup 10 is incorporated into an electric guitar 100 and converts vibrations of strings 102 into electrical signals. The electric guitar 100 includes a body 101 and strings 102. In a state in which the pickup 10 is installed in the electric guitar 100 and disposed in or on the body 101, the strings 102 extends across both a bobbin 21A and a bobbin 21B. FIG.

9 illustrates two pickups 10 installed on the electric guitar, but the number of the pickups is not limited thereto.

### {2. Coil Configuration}

As shown in FIGS. 1 to 3, the coil 2 includes a coil 2A and a coil 2B. The coils 2A and 2B include the bobbins 21A and 21B, respectively. Coil wires 22A and 22B are wound on the bobbins 21A and 21B, respectively. In the present embodiment, the bobbin 21A is an example of a first bobbin according to the present disclosure, and the bobbin 21B is an example of a second bobbin according to the present disclosure.

As shown in FIG. 1, the bobbin 21A has six holes 23A provided at equal intervals. The hole 23A is a hole penetrating through the bobbin 21A in the up-down direction. In each hole 23A, the pole piece 5A is inserted. As shown in FIG. 1, the bobbin 21B has six holes 23B provided at equal intervals. The hole 23B is a hole penetrating through the bobbin 21B in the up-down direction. In each hole 23B, the pole piece 5B is inserted. In the present embodiment, the pole piece 5A is an example of a first pole piece according to the present disclosure, and the pole piece 5B is an example of a second pole piece according to the present disclosure.

The pole pieces 5A and 5B are members made of steel and take on magnetic force by contacting a magnet 4, which will be described below. In the present embodiment, the pole piece 5A is a cylindrical steel member (slug), and the pole piece 5B is a steel screw (screw). By the pole pieces 5A and 5B taking on magnetism, the two coils 2A and 2B are formed by the pole pieces 5A and 5B, the bobbins 21A and 21B, and the coil wires 22A and 22B. In this way, the pickup 10 according to the present embodiment is a humbucker having the two coils 2A and 2B. Since the pole piece 5B has a screw structure, the arrangement of the pole piece 5B in the up-down direction can be adjusted. As shown in FIGS. 1 to 3, the two coils 2A and 2B are arranged in parallel on the base plate 3. More specifically, the coils 2A and 2B are arranged in parallel so that the longitudinal directions thereof are parallel to the Z direction.

### {3. Base Plate Configuration}

As shown in FIG. 1, the base plate 3 is arranged below the coil 2. In the present embodiment, the base plate 3 is a printed circuit board. Specifically, the base plate 3 is a printed circuit board made of a glass epoxy resin material and has a circuit pattern formed on an upper surface thereof. A magnet 4 is arranged on a bottom surface of the base plate 3.

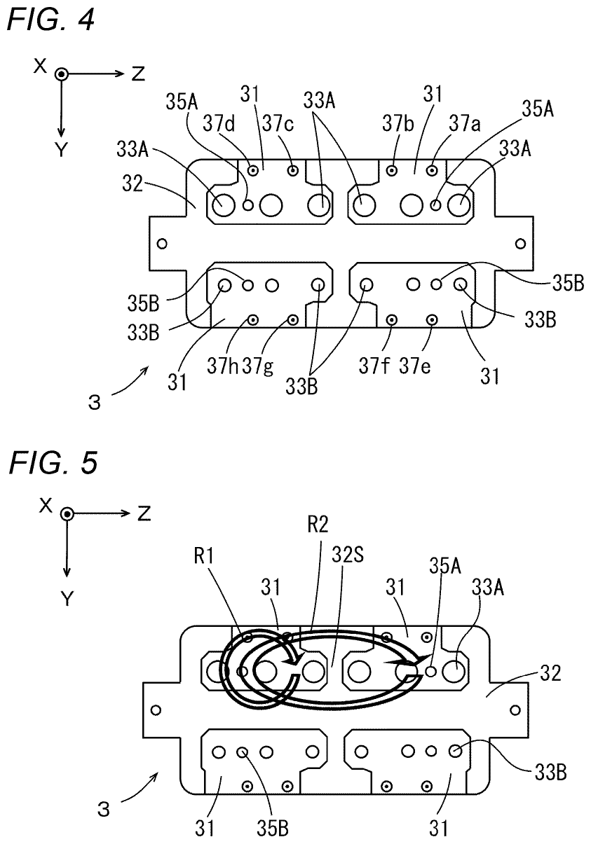

FIG. 4 is a plan view of the base plate 3. The base plate 3 has six holes 33A provided at equal intervals, and in the base plate 3, the pole pieces 5A are inserted. The six holes 33A are provided to positionally align with the six holes 23A of the bobbin 21A. In addition, two screw holes 35A for inserting screws 6A are provided on inner sides of the holes 33A at both left and right ends, respectively. The base plate 3 has six holes 33B provided at equal intervals, and in the base plate 3, the pole pieces 5B are inserted. The six holes 33B are provided to positionally align with the six holes 23B of the bobbin 21B. In addition, two screw holes 35B for inserting screws 6B are provided on inner sides of the holes 33B at both left and right ends, respectively.

As shown in FIG. 4, circuit pattern forming areas 31 are arranged at four locations on an upper surface of the base plate 3. An area 32 other than the circuit pattern forming areas 31 at four locations is not formed with a circuit pattern. That is, the area 32 is an area that is formed of glass epoxy resin and does not include a conductor. The holes 33A and 33B and the screw holes 35A and 35B are all provided in the circuit pattern forming areas 31. Additionally, the circuit pattern forming areas 31 are provided with a plurality of terminals 37a to 37h. Note that the upper surface of the base plate 3 is an example of a first surface of a base plate according to the present disclosure. The bottom surface of the base plate 3 is an example of a second surface of the base plate according to the present disclosure.

As shown in FIG. 1, a lead wire 36 is connected to the terminal 37e. The terminal 37e and the terminal 37a are connected by a wiring 38a. One end (not shown) of the coil wire 22A is connected to the terminal 37a. The other end (not shown) of the coil wire 22A is connected to the terminal 37b. The terminal 37b and the terminal 37f are connected by a wiring 38b. The terminal 37f and the terminal 37g are connected by a wiring 38c. One end 22Ba of the coil wire 22B is connected to the terminal 37g. The other end 22Bb of the coil wire 22B is connected to the terminal 37h. A lead wire 39 is connected to the terminal 37h. With this configuration, the coils 2A and 2B are connected in parallel between the lead wires 36 and 39. The lead wires 36 and 39 are connected to a control unit of a stringed instrument (e.g., an electric guitar). With this, the electric signals converted in the pickup 10 are provided to the control unit of the stringed instrument.

### {4. Magnet Configuration}

As shown in FIG. 1, the magnet 4 arranged below the base plate 3 has a substantially rectangular shape in plan view. The magnet 4 is arranged such that, when assembling the pickup 10, an upper surface thereof contacts the bottom surface of the base plate 3. In addition, the magnet 4 is arranged such that, when assembling the pickup 10, it contacts the pole pieces 5A and 5B in an area below the bottom surface of the base plate 3. In the present embodiment, an iron chromium cobalt magnet (FCC magnet) is used as the magnet 4. In addition, magnets such as Alnico, ferrite, samarium cobalt, or neodymium may be used as the magnet 4.

The magnet 4 has two screw holes 45A formed for inserting the screws 6A. The two screw holes 45A are provided to positionally align with the two screw holes 35A provided in the base plate 3. A front surface of the magnet 4 is formed with six recessed portions 43B at equal intervals to accommodate parts of the pole pieces 5B. The six recessed portions 43B are provided to positionally align with the six holes 33B of the base plate 3 and the six holes 23B of the bobbin 21B. The recessed portion 43B is an example of a “hole configured to allow a first pole piece or a second pole piece to be inserted therein” according to the present disclosure. In addition, recessed portions 45B to accommodate parts of the screws 6B are formed at two locations on inner sides of the recessed portions 43B at both left and right ends, respectively. The two recessed portions 45B are provided to positionally align with the two screw holes 35B provided in the base plate 3.

### {5. Assembly Method}

The coil 2, base plate 3, magnet 4, and pole pieces 5A and 5B described above are combined and assembled in the up-down direction and fastened with the screws 6A and 6B, constituting the pickup 10. Specifically, the positions of the six holes 23A of the bobbin 21A and the six holes 33A of the base plate 3 are aligned, and the six pole pieces 5A are then inserted in the holes 23A and 33A. The pole pieces 5A penetrating the bobbin 21A and the base plate 3 contact the upper surface of the magnet 4. In addition, the positions of the six holes 23B of the bobbin 21B, the six holes 33B of the base plate 3, and the six recessed portions 43B of the magnet 4 are aligned, and the six pole pieces 5B are then inserted in the holes 23B and 33B. The pole pieces 5B penetrating the bobbin 21B and the base plate 3 contact the recessed portions 43B of the magnet 4. In this state, the screws 6A are inserted in the screw holes 45A and the screw holes 35A, and further into screw holes (not shown) formed in the bottom surface of the bobbin 21A, where they are screw-fixed. In addition, the screws 6B are inserted in the recessed portions 45B and the screw holes 35B, and further into screw holes (not shown) formed in the bottom surface of the bobbin 21B, where they are screw-fixed. As a result, the coils 2A and 2B, the base plate 3, and the magnet 4 are fixed.

As described above, in the pickup 10 of the present embodiment, the bobbin 21A and the bobbin 21B are arranged on the upper surface of the base plate 3, and the magnet 4 is arranged on the bottom surface of the base plate 3. This reduces the complexity of the assembly process for the pickup 10. That is, it is sufficient to simply fix the coil 2 and the magnet 4 above and below the base plate 3, making the assembly process easier to perform. In addition, since the bobbin 21A and the bobbin 21B are directly arranged on the upper surface of the base plate 3, the verticality of the bobbin 21A and bobbin 21B with respect to the plane of the base plate 3 is improved. This improves the verticality of the pole pieces 5A and 5B with respect to the plane of the base plate 3, thereby enhancing contact precision between the pole pieces 5A and 5B and the magnet 4. As such, the pickup 10 of the present embodiment has high assembly precision and high contact precision between the pole pieces 5A and 5B and the magnet 4, resulting in a higher gain.

In addition, in the pickup 10 of the present embodiment, a printed circuit board is used as the base plate 3. With this, the linearity or flatness of the base plate 3 is ensured, resulting in improved assembly precision of the pickup 10.

In addition, in the pickup 10 of the present embodiment, the magnet 4 is provided with the recessed portions 43B for inserting the pole pieces 5B. This makes it possible to extend the magnet 4 to the periphery of the pole pieces 5B, thereby increasing a volume of the magnet 4. As a result, a strong magnetic force can be imparted to the pole pieces 5A and 5B.

In addition, in the pickup 10 of the present embodiment, the circuit pattern is formed on the base plate 3, and the end portions of the coil wires 22A and 22B are connected to the circuit pattern formed on the base plate 3. This significantly facilitates the wiring process in the assembly process for the pickup 10. In addition, the length of the lead wire around the pickup 10 is shortened, allowing for a simpler configuration.

In addition, in the pickup 10 of the present embodiment, eddy current that is generated on the base plate 3 can be suppressed. FIG. 5 is a view showing eddy current generated on base plate 3. As described above, the base plate 3 has the area 32 where no circuit pattern is formed, and the four circuit pattern forming areas 31 are separated. That is, the circuit pattern is configured so that a loop-shaped path is not formed as much as possible. For example, as shown in FIG. 5, a pattern-cut area 32S is formed between two circuit pattern forming areas 31. With this, there is a possibility that the eddy current represented by RI will be generated, but the eddy current represented by R2 will not be generated. In this way, in the pickup 10 of the present embodiment, the generation of eddy current is suppressed, thereby preventing a reduction in the gain of the pickup 10 and suppressing the influence of noise on conversion from string vibrations to electric signals.

In addition, in the pickup 10 of the present embodiment, the pole piece 5A is

assembled such that the bottom surface thereof contacts the upper surface of the magnet 4. In structures of the related art where the magnet and the coil are arranged on the base plate, the pole piece with a slug structure is structured to make linear contact with the magnet from the transverse direction. According to the present embodiment, since the bottom surface of the pole piece 5A is in surface contact with the upper surface of the magnet 4, the contact area between the pole piece 5A and the magnet 4 is increased, allowing a strong magnetic force to be imparted to the pole piece 5A.

### 2. Second Embodiment

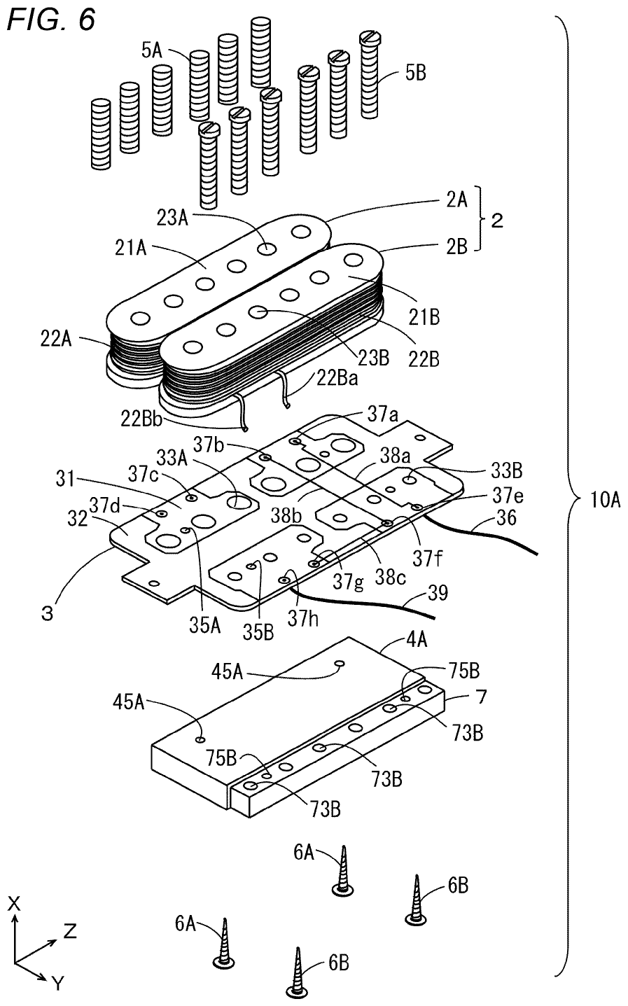

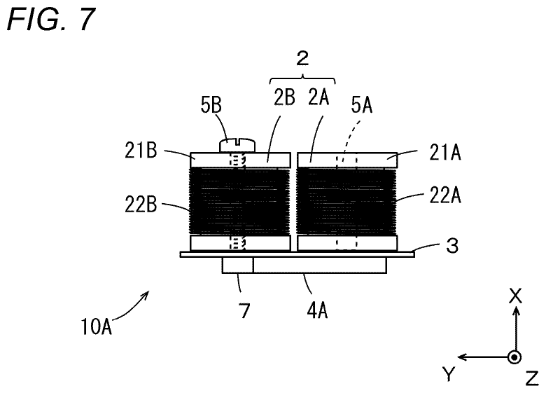

Next, a pickup 10A according to a second embodiment of the present disclosure will be described. Among the configurations of the pickup 10A, the configurations of the coil 2, base plate 3, and pole pieces 5A and 5B are similar to those of the first embodiment. In the pickup 10A, a configuration of a magnet 4A is different from the pickup 10. FIG. 6 is an exploded view of the pickup 10A according to the second embodiment. FIG. 7 is a side view of the pickup 10A.

As shown in FIG. 6, the magnet 4A does not have the recessed portions 43B and 45B as in the magnet 4. A spacer 7, which is a metal plate, is arranged on a front surface side of the magnet 4A. The magnet 4A and the spacer 7 are arranged such that, when assembling the pickup 10, respective upper surfaces thereof contact the bottom surface of the base plate 3. In addition, a back surface of the spacer 7 is arranged such that, when assembling the pickup 10, it contacts the front surface of the magnet 4 in an area below the bottom surface of the base plate 3. In the present embodiment, the spacer 7 is made of steel. The spacer 7 has six holes 73B provided at equal intervals. The hole 73B is a hole penetrating through the spacer 7 in the up-down direction. In each hole 73B, the pole piece 5B is inserted. Alternatively, the hole 73B may not penetrate through the spacer 7. In addition, two screw holes 75B for inserting screws 6B are provided on inner sides of the holes 73B at both left and right ends, respectively.

The assembly method of the pickup 10A is similar to that of the pickup 10. In the pickup 10A, the screws 6B are inserted in the screw hole 75B, and then inserted in the base plate 3 and the bobbin 21B, where they are screw-fixed. The pole pieces 5B pass through the holes 23B of the bobbin 21B and the holes 33B of the base plate 3, and are then inserted in the holes 73B of the spacer 7. The magnetic force of the magnet 4A is imparted to the pole pieces 5B inserted in the holes 73B of the spacer 7 via the steel spacer 7.

### 3. Features and Effects of Embodiments

As described above, a pickup for a stringed instrument according to the present disclosure includes a base plate, a first bobbin and a second bobbin arranged parallel with each other on a first surface of the base plate, a first pole piece inserted in the first bobbin and penetrating the base plate, a second pole piece inserted in the second bobbin and penetrating the base plate, and a magnet arranged on a second surface of the base plate which is opposite to the first surface such that the magnet contacts the first pole piece and the second pole piece.

The bobbin and magnet are arranged with the base plate interposed therebetween, making the assembly process easy. Since the first bobbin and the second bobbin are arranged on the first surface of the base plate, it is easy to maintain the verticality of the axes of the bobbins with respect to the base plate. The improvement in assembly workability can lead to an increase in the gain of the pickup.

The base plate may include a non-magnetic material.

The eddy current that is generated on the base plate can be suppressed.

The base plate may include a printed circuit board.

Since the linearity (flatness) of the base plate is ensured, the assembly workability of the pickup is improved. The improvement in assembly workability can lead to an increase in the gain of the pickup.

The printed circuit board may include a glass epoxy resin material.

The strength of the base plate is improved.

The magnet may be provided with a hole configured to allow the first pole piece or the second pole piece to be inserted therein.

The volume of the magnet can be expanded.

A metal plate may be further provided, and the metal plate may be arranged on the second surface of the base plate which is opposite to the first surface such that the metal plate contacts the magnet, and in the metal plate, the first pole piece or the second pole piece may be inserted.

A structure can be constructed to magnetize the pole piece without processing the magnet.

A circuit pattern may be formed on the base plate, and a first coil wire wound around the first bobbin and a second coil wire wound around the second bobbin may be connected to the circuit pattern.

The wiring process for the pickup becomes easier. The length of the lead wire around the pickup is shortened, allowing for a simpler structure.

The circuit pattern may have an area configured to cut a loop-shaped path.

The eddy current that is generated on the base plate can be suppressed.

The first pole piece or the second pole piece may be in surface contact with the magnet.

By increasing the contact surface between the pole piece and the magnet, the gain of the pickup can be increased.

A guitar according to the present embodiment includes the pickup for a stringed instrument as described above.

### 4. Modifications

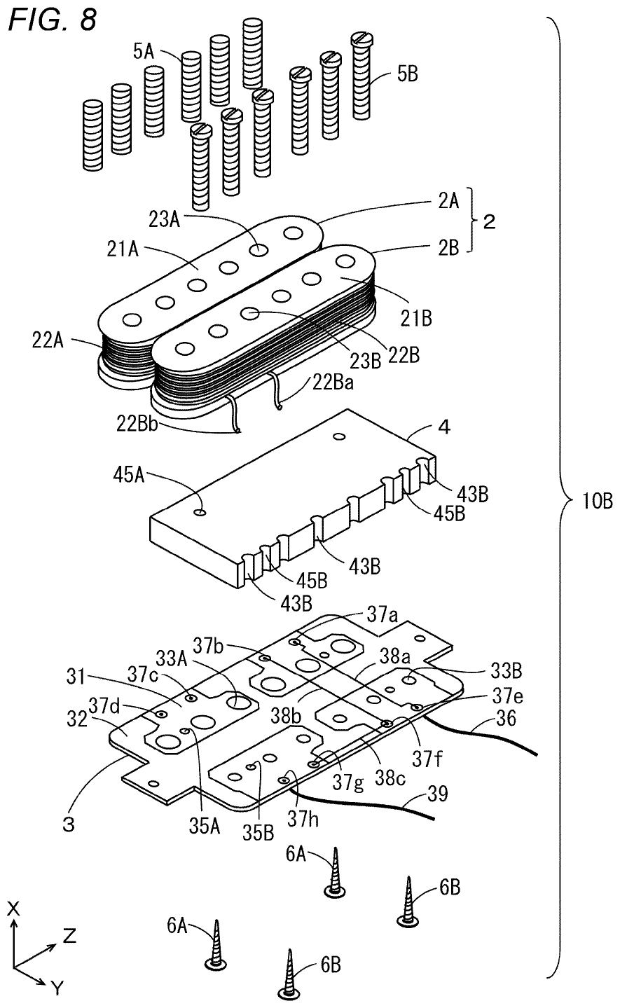

FIG. 8 is a view showing a pickup 10B according to a modification. The pickup 10B is an example in which the positional relationship between the base plate 3 and the magnet 4 is reversed compared to the pickup 10 of the first embodiment. The pole pieces 5A pass through the holes 23A, and then come into contact with the upper surface of the magnet 4. The pole pieces 5B pass through the holes 23B and are then accommodated in the recessed portions 43B. The screws 6A are inserted in the order of the screw holes 35A and 45A, and then inserted in the screw holes in the bottom surface of the bobbin 21A, where they are screw-fixed. The screws 6B are inserted in the screw holes 35B and the recessed portions 45B, and further into the screw holes in the bottom surface of the bobbin 21B, where they are screw-fixed. Note that, in the drawing, the same base plate 3 as in the first embodiment is used, but the holes 33A and 33B need not be provided.

In this modification as well, since a printed circuit board is used as the base plate 3, the surface precision of the base plate 3 is high, allowing for the high assembly precision of the pickup 10B. With this, the contact precision between the pole pieces 5A and 5B and the magnet 4 is improved, allowing for an increase in the gain of the pickup.

### 5. Other Embodiments

In the above embodiments, a printed circuit board is used as the base plate 3. As the base plate 3, other members that can maintain high surface precision can also be used. In addition, using a non-magnetic material for the base plate 3 can suppress the eddy current that is generated on the base plate 3.

In the pickups 10 and 10A of the first and second embodiments, the coils 2 and the magnets 4 and 4A are arranged above and below the base plate 3. That is, the coil 2 and the magnets 4 and 4A are assembled on the upper and bottom surfaces of the base plate 3 through surface contact. Therefore, instead of using the screws 6A and 6B, these components may also be fixed by an adhesive material.

In the first embodiment, both the recessed portion 43B for inserting the pole piece 5B and the recessed portion 45B for inserting the screw 6B have a semicircular shape in plan view. As another embodiment, the hole for inserting the pole piece 5B and the screw hole for 10 inserting the screw 6B may be formed in a circular shape in plan view. This can further increase the volume of the magnet 4. CLAIMS

1. A pickup for a stringed instrument that uses at least a first string, the pickup comprising:
a base plate comprising a first surface and a second surface opposite to the first surface;
a first bobbin and a second bobbin arranged parallel with each other on the first surface of the base plate so that the first string extends across both the first and second bobbin in a state where the pickup is installed in the string instrument;
a magnet disposed on the second surface of the base plate;
a first pole piece extending into the first bobbin; and
a second pole piece extending into the second bobbin,
wherein the magnet contacts at least one of the first pole piece or the second pole piece.

2. The pickup for a stringed instrument according to claim 1, wherein the base plate comprises a non-magnetic material.

3. The pickup for a stringed instrument according to claim 1, wherein the base plate comprises a printed circuit board.

4. The pickup for a stringed instrument according to claim 3, wherein the printed circuit board comprises a glass epoxy resin material.

5. The pickup for a stringed instrument according to claim 1, wherein the magnet includes a hole that receives the first pole piece or the second pole piece.

6. The pickup for a stringed instrument according to claim 1, further comprising:
a metal plate arranged on the second surface of the base plate,
wherein the metal plate contacts the magnet, and
wherein the metal plate receives one of the first pole piece or the second pole piece.

7. The pickup for a stringed instrument according to claim 3, wherein:
the base plate includes circuit pattern forming areas each providing a circuit pattern,
a first coil wire is wound around the first bobbin,
a second coil wire is wound around the second bobbin, and
the first coil wire and the second coil wire are connected to the circuit patterns.

8. The pickup for a stringed instrument according to claim 7, wherein each circuit pattern is shaped to provide a loop-shaped path.

9. The pickup for a stringed instrument according to claim 1, wherein at least one of the first pole piece or the second pole piece is in surface contact with the magnet.

10. A guitar comprising:
a body on which a first string extends; and
a pickup disposed in or on the body and comprising:
a base plate comprising a first surface and a second surface opposite to the first surface;
a first bobbin and a second bobbin arranged parallel with each other on the first surface of the base plate so that the first string extends across both the first and second bobbin;
a magnet disposed on the second surface of the base plate;
a first pole piece extending into the first bobbin; and
a second pole pieces extending into the second bobbin, wherein the magnet contacts at least one of the first or second pole piece.
